(19) United States
(12) Patent Application Publication
(10) Pub. No.: US 2020/0097808 A1
(43) Pub. Date: Mar. 26, 2020

(54) Pattern Identification in Reinforcement Learning

(71) Applicant: INTERNATIONAL BUSINESS MACHINES CORPORATION, ARMONK, NY (US)

(72) Inventors: John J. Thomas, Fishkill, NY (US); Aleksandr E. Petrov, Acton, MA (US); Aishwarya Srinivasan, New York, NY (US); Avijit Chatterjee, White Plains, NY (US)

(21) Appl. No.: 16/138,715

(22) Filed: Sep. 21, 2018

(51) Int. Cl. G06N 3/08

(52) U.S. Cl. CPC G06N 3/08

(57) ABSTRACT

A computer-implemented mechanism is disclosed. The mechanism includes receiving a data signal, and comparing the data signal to one or more predefined patterns to determine one or more long/short term predictor scores. A discount factor is generated in response to the long/short term predictor scores. A set of expected rewards is generated. The set of expected rewards correspond to an action set specific to the data signal. The set of expected rewards are generated according to reinforced learning. The set of expected rewards are adjusted based on the discount factor. A selected action is selected from the action set based on the set of expected rewards. The selected action is initiated.

### BACKGROUND

The present disclosure relates to the field of decision making via artificial intelligence (AI). An AI is a machine element that mimics human cognitive functions, such as learning, problem solving, and/or decision making. For example, an AI can be configured to perceive an operating environment and take steps to maximize the probability of achieving predefined goals. Many technical approaches may be employed to create and maintain an AI in a computing environment. Such computing environments may include a multiple interconnected computing devices, such as cloud network servers and/or dedicated servers in a datacenter. The operating environments and configurations of AI systems may vary depending on the goals of the corresponding AI.

### SUMMARY

Aspects of the present disclosure provide for a computer program product for selecting an action based on reinforced learning. The computer program product comprises a computer readable storage medium having program instructions embodied therewith. The program instructions are executable by a processor to cause the processor to perform associated tasks. The processor can receive a data signal, and compare the data signal to one or more predefined patterns to determine one or more long/short term predictor scores. The processor can generate a discount factor in response to the long/short term predictor scores, and generate a set of expected rewards corresponding to an action set specific to the data signal. The expected rewards are generated according to reinforced learning. The set of expected rewards are adjusted based on the discount factor. A selected action is selected from the action set based on the set of expected rewards. This supports initiating the selected action.

Other aspects of the present disclosure provide for a computer-implemented method. The method comprises receiving a data signal, and comparing the data signal to one or more predefined patterns to determine one or more long/short term predictor scores. A discount factor is generated in response to the long/short term predictor scores. A set of expected rewards are generated that correspond to an action set specific to the data signal. The set of expected rewards are generated according to reinforced learning. The set of expected rewards are adjusted based on the discount factor. A selected action is selected from the action set based on the set of expected rewards. This supports initiating the selected action.

Other aspects of the present disclosure provide for a computing device. The computing device comprises a memory configured to store one or more predefined patterns, store an action set; and store a deep neural network. The computing device also includes a receiver configured to receive a data signal. The computing device also includes a processor coupled to the memory and the receiver. The processor is configured to compare the data signal to the predefined patterns to determine one or more long/short term predictor scores. The processor generates a discount factor in the deep neural network in response to the long/short term predictor scores. The processor also generates a set of expected rewards corresponding to an action set specific to the data signal, the expected rewards generated according to reinforced learning. The processor adjusts the set of expected rewards based on the discount factor. The processor further selects a selected action from the action set based on the set of expected rewards. The processor can also initiate the selected action.

### BRIEF DESCRIPTION OF THE DRAWINGS

FIG. 1 is a block diagram of an example reinforced learning system in accordance with various embodiments.

FIG. 2 is a block diagram of an example system architecture for selecting an action with reinforced learning and based on pattern matching in accordance with various embodiments.

FIG. 3 is a block diagram of an example system architecture for selecting instrument trading actions with reinforced learning and based on pattern matching in accordance with various embodiments.

FIG. 4 is a block diagram of an example system architecture for selecting autonomous driving actions with reinforced learning and based on pattern matching in accordance with various embodiments.

FIG. 5 is a block diagram of an example system architecture for selecting healthcare actions with reinforced learning and based on pattern matching in accordance with various embodiments.

FIG. 6 is a block diagram of an example computing device in accordance with various embodiments.

FIG. 7 is a flowchart of an example method of selecting an action with reinforced learning and based on pattern matching in accordance with various embodiments.

### DETAILED DESCRIPTION

Reinforced learning is an AI implementation. Reinforced learning is applied to an agent, which is an AI construct. The agent includes a neural network that can be trained to take actions based on environmental states in an attempt maximize rewards. A neural network is a multi-layered matrix of nodes with various weights. Training data is applied to adjust the weights. Once trained, the agent can employ the neural network to select actions based on data inputs. Hence, such an agent makes decisions based on a data signal at a specified point in time. Such an approach may result in the selection of optimal actions in some cases. However, certain data signals may exhibit known patterns. As examples, a stock market index, autonomous driving input, and biological patient data may all provide data signals with repeatable patterns. A trained agent making point in time decisions may be unable to recognize such patterns, and hence may make sub-optimal decisions when such patterns arise.

Disclosed herein are embodiments that equip an AI agent generated according to reinforced learning with the ability to recognize patterns and alter selections of corresponding actions accordingly. For example, the agent may employ dynamic time warping to compare a data signal with one or more predefined patterns. The dynamic time warping analysis generates a long/short term predictor scores, such as similarity indices. The agent employs a deep neural network to process the data signal, and determine a set of expected rewards corresponding to actions in an action set. The agent sets/adjusts a discount factor based on the current long/short term predictor scores. The agent applies the discount factor to the set of expected rewards. This has the effect of discounting certain expected rewards. The agent can then select an action based on the expected rewards. As such, certain expected rewards and corresponding actions are discounted when the long/short term predictor scores indicates a likelihood of a pattern match. Further, contextual data that is related to the data signal can be employed to generate context data. As used herein, context data is contextual data that provides context for the data signal. The context data can also be employed to adjust the expected rewards, and hence adjust selection of an action from a predefined action set. Also disclosed are several use cases that apply pattern matching to the operation of an agent. In an example embodiment, an agent can receive a data signal that indicates stock market valuations. The agent can also obtain contextual financial information as context data. The agent can compare the changes in the data signal with patterns to determine when a known market pattern is occurring. The agent can then consider the context data and forming patterns to select an appropriate action (e.g., buy, sell, hold, etc.). In another example embodiment, the data signal can be vehicle sensor data in an autonomous driving context. The agent can obtain contextual information regarding travel conditions to generate context data. The agent can also compare the vehicle sensor data to patterns in order to spot road hazards. The agent can then consider the context data and the road hazard when selecting an action for the vehicle (e.g., speed up, slow down, stop, etc.). In yet another example embodiment, the data signal can be patient outcome data analyzed for medical treatment. The agent can generate context data by obtaining contextual information, such as biometric data, imaging data, etc., that is relevant to a patient treatment. The agent can then consider the context data and patterns in the patient outcome data when selecting a treatment action (e.g., new treatment, change treatment, stop treatment, etc.). While three example applications of this technique are shown for purposes of illustration, the disclosed pattern matching mechanisms can be applied to any agent that selects actions based on expected rewards in an environment with known patterns exhibited in an input data signal.

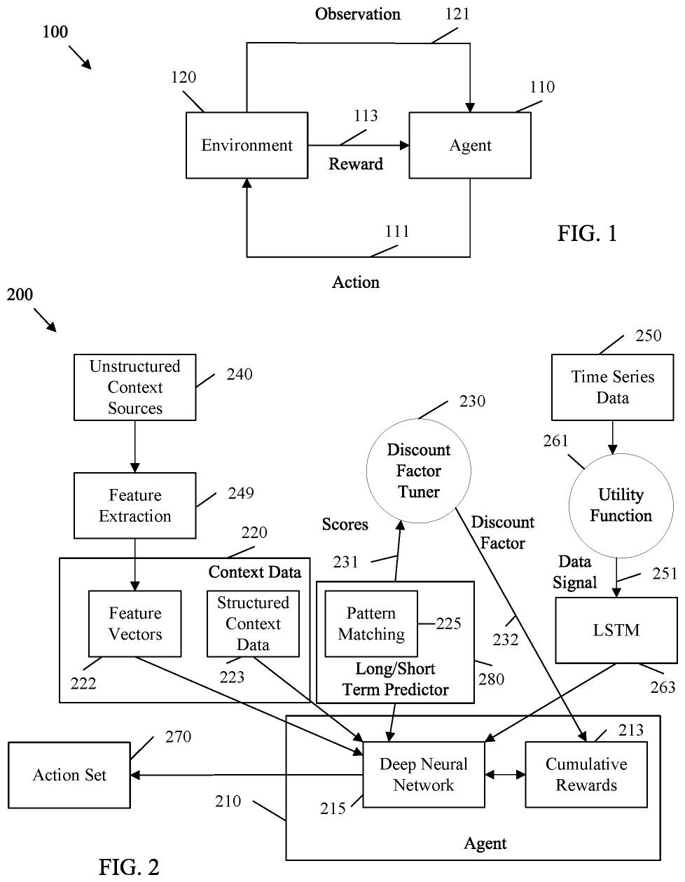

FIG. 1 is a block diagram of an example reinforced learning system 100 in accordance with various embodiments. The reinforced learning system 100 includes an agent 110 that interacts with an environment 120. The agent 110 is an autonomous entity which makes observations 121 of the environment 120 via sensors, initiates actions 111 upon the environment 120 using actuators, and directs such activity towards achieving goals, for example via rewards 113. The environment 120 is the surroundings and conditions within which the agent 110 operates. The environment 120 may vary significantly depending on the problem to which the agent 110 is applied. As non-limiting examples, the environment 120 may include financial realities in a stock trading context, physical realities related to road conditions in an autonomous driving context, and patient health realities in a healthcare context.

The reinforced learning system 100 applies a training phase to the agent 110. In the training phase, the environment 120 includes training data. Once the agent 110 is trained, the reinforced learning system 100 allows the agent 110 to make actual decisions in an operational phase. During the operational phase, the environment 120 may include real time data. During the operational phase, the agent 110 may act according to supervised machine learning. In such a case, the agent 110 initiates actions 111, but a human user is allowed to approve or refuse such actions 111 before they occur. The agent 110 may also act in an unsupervised capacity during the operational phase, in which case the agent 110 initiates actions 111 that occur immediately and without human intervention.

The agent 110 includes a deep neural network. A deep neural network is a multi-layered matrix of nodes that process inputs. A first layer of nodes includes first layer nodes that accept direct inputs. A second layer of nodes include second layer nodes that accept weighted input from one or more first layer nodes. Additional layers of nodes can be employed as desired, with an output layer of nodes that output values from the preceding layers. An action 111 can then be selected based on the output at the output nodes. Reinforced learning system 100 trains the agent 110 by altering the weights between the nodes in the neural network in order to maximize the rewards 113 achieved based on the actions 111 taken. For example, the agent 110 can be exposed to an environment 120 of training data. The agent 110 can make randomized decisions on which actions 111 to take, can make observations 121 regarding the results of the action 111, and determine rewards 113 resulting from the action 111. The agent 110 employs an error calculation to determine the differences between the achieved rewards 113 and the optimal reward 113. The agent 110 can also use observations 121 to determine effects of actions 111 on the environment 120. The agent 110 can then update the weights between the nodes in the neural network based on the observations 121 and achieved rewards 113 relative to the possible rewards 113. The agent 110 can then continue to take more actions 111, receive more rewards 113, and continue to adjust weights. As training continues, the agent 110 progressively discounts random actions 111, and progressively emphasizes selection of actions 111 based on past rewards 113. Such a process continues until the agent 110 is trained and ready for use in the operational phase, during which the agent 110 is transitioned for use with respect to a live environment 120.

As a particular example, the agent 110 can be exposed to the environment 120 in batches in a process called experience replay. In experience replay, the agent 110 is trained for a number of episodes, which is the number of times the agent 110 is exposed to training data points from the environment 120. This allows the agent 110 to learn sequentially with actions 111 taken stochastically, which acts as training samples for the agent's 110 neural network. When time series data is employed, the agent 110 can employ a sliding window technique with predefined window sizes (e.g., a window size of n time periods) to determine the batch sizes. The agent 110 is trained and back-tested on the training data (e.g., historical data). The resulting actions 111 are compared with additional training data (e.g., later historical data) to determine how well the rewards 113 of the actions 111 taken match the optimal rewards 113. The agent's 110 neural network weights are then adjusted accordingly.

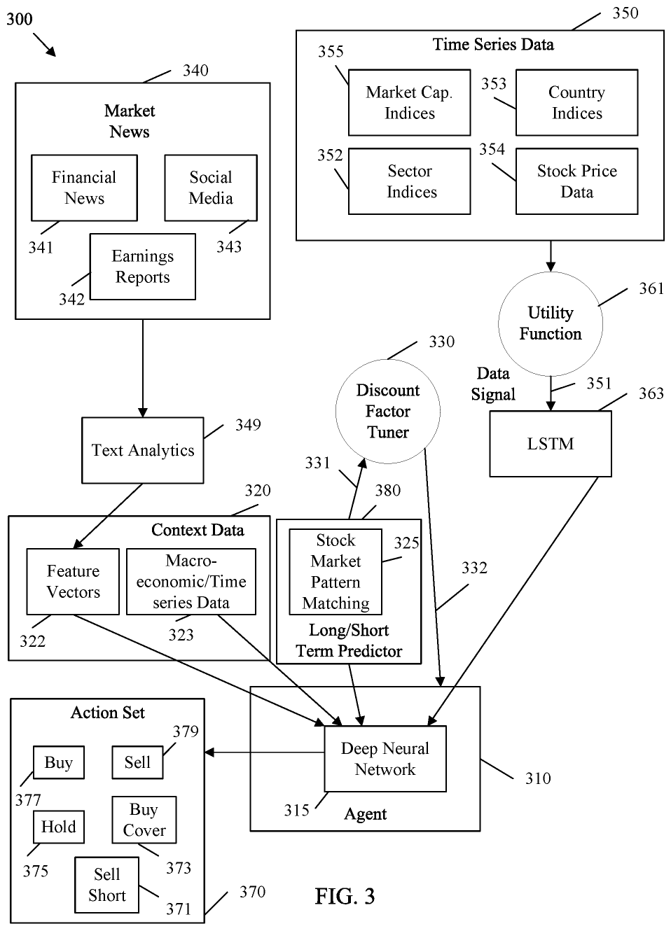

FIG. 2 is a block diagram of an example system architecture 200 for selecting an action with reinforced learning and based on pattern matching in accordance with various embodiments. For example, system architecture 200 can be employed to provide information (e.g., observations 121 and rewards 113) from an environment 120 to an agent 110 to initiate an action 111. The system architecture 200 has access to time series data 250 and unstructured context sources 240, which are implementations of an environment 120. The time series data 250 includes one or more data signals 251 than an agent 210 reviews to determine actions to take (e.g., actions 111) from an action set 270. The agent 210 is an example implementation of an agent 110. The unstructured context sources 240 represent contextual data that provides context for movements in the data signal 251 in the time series data 250. Hence, the agent 210 makes decisions based on the time series data 250 in light of the contest provided by the unstructured context sources 240.

The time series data 250 is forwarded to a utility function 261. The utility function 261 adjusts the time series data 250 to create data signal(s) 251 that are usable by the agent 210. For example, the utility function 261 may convert the time series data 250 to a trend by calculating the inter time period difference across the n time intervals in a batch during training, where n is a predetermined integer. The utility function 261 can also normalize the trend data via discrete space using binning techniques. Converting the data into a discrete form allows the system architecture 200 to employ a wide variety of types of time series data 250. The utility function 261 may convert the time series data 250 into one or more n-sized trend vectors for storage in a long/short term memory (LSTM) 263.

The LSTM 263 is a memory device configured to store the data signals 251 from the time series data 250 while such data signals 251 are considered by the agent 210. For example, the LSTM 263 may store the n-sized vector(s) into a multi-dimensional input that captures trends in the data signal for use by the agent 210 along with context data.

The data from the unstructured context sources 240 is stored as context data 220. The context data 220 is contextual data that provides context for changes in the data signal 251 from the time series data 250. For example, the functions of architecture 200 generate context data 220 describing data signal 251 context based on quantitative data from the unstructured context sources 240. The unstructured context sources 240 may contain unstructured data such as images, documents, files, etc. Unstructured data contains information that is not in a standardized format. The unstructured data from the unstructured context sources 240 can be forwarded to feature extraction 249. Feature extraction 249 is a function or group of functions configured to extract and process unstructured data from the unstructured context sources 240 and convert such data into quantitative data in a format usable by the agent 210. Hence, feature extraction 249 extracts quantitative data from unstructured context sources 240 related to the data signal. For example, feature extraction 249 may include image recognition functions to obtain quantitative information from images. Feature extraction 249 may include text analytics for obtaining quantitative data from text files. The extracted quantitative data is stored in feature vectors 222 as context data 220. A feature vector 222 is a data structure that stores context information in a predetermined format that is understood by the agent 210. Unstructured context sources 240 that contain structured data can be stored directly as structured context data 223 along with other context data 220.

The context data 220 also includes a long/short term predictor function 280. The long/short term predictor function 280 employs a predictive model to determine when to emphasize short term rewards or long term rewards. One example long/short term predictor function 280 is a pattern matching 225 function. Pattern matching 225 continually compares the data signal(s) 251 from the time series data 250 (e.g., as stored in the LSTM 263) with one or more predefined patterns (e.g., which may also be stored in the LSTM 263). Pattern matching 225 applies a mechanism, such as dynamic time warping, to compare the data signal(s) 251 to the pattern(s) (e.g., templates). Such a comparison allows the pattern matching 225 function to determine one or more long/short term predictor scores 231, such as similarity indices. A long/short term predictor score 231 is a score that indicates a result of the predictive model. For example, similarity indices resulting from pattern matching 225 indicate a level of similarity between a data signal 251 and a predefined pattern. Hence, pattern matching 225 may generate a long/short term predictor scores 231/similarity index for each predefined pattern. Other example long/short term predictor functions 280 may also be employed to adjust a discount factor tuner 230. For example, other example predictive models implemented as long/short term predictor functions 280 may employ pattern matching on other context data 220 items to determine when to emphasize short term rewards or long term rewards.

A discount factor tuner 230 considers the long/short term predictor scores 231. The discount factor tuner 230 is a function that generates one or more discount factors 232 in response to the long/short term predictor scores 231. A discount factor 232 is a factor that varies based on external environmental data. The discount factor tuner 230 can increase or decrease the discount factors 232 depending on the long/short term predictor scores 231. For example, certain patterns may be associated with a high probability of future rewards. Other patterns may be associated with a high probability of declining future rewards. Accordingly, the discount factor tuner 230 can adjust the discount factors 232 to encourage seeking short term rewards or long term rewards, depending on the relevant pattern.

The agent 210 is configured to receive the context data 220, the data signal 251 from the time series data 250, and the discount factor 232. The agent 210 includes a deep neural network 215. As discussed with respect to agent 110, a deep neural network 215 is a multi-layered matrix of nodes that processes inputs. A deep neural network 215 may include more than four layers of nodes to be considered deep. The deep neural network 215 accepts the context data 220 and the data signal 251 as inputs at the first layer/input layer of nodes. The deep neural network 215 processes the context data 220 and the data signal 251 through the node layers. The nodes in the output layer of the deep neural network 215 are associated with actions in an action set 270. The action set 270 includes a set of actions that are specific to the data signal 251. Examples of actions in an action set 270 are discussed with respect to use cases in the FIGs. below. The nodes in the output layer of the deep neural network 215 generate numerical output values based on the context data 220 and the data signal 251. The generated numerical output values indicate a set of cumulative rewards 213 that correspond to the action set 270. Specifically, the cumulative rewards 213 indicate the expected rewards for each action in the action set 270. Hence, highest expected reward from the cumulative rewards 213 indicates the action that should be selected from the action set 270. As the cumulative rewards 213 are generated by processing via the nodes in the deep neural network 215, the set of expected rewards in the cumulative rewards 213 are generated based in part on the context data 220 and based in part on the data signal 251.

The cumulative rewards 213 are expected rewards generated according to reinforced learning. For example, training data acting as context data 220 and the data signal 251 is applied to the deep neural network 215. The deep neural network 215 outputs cumulative rewards 213 based on random actions. The agent 210 determines the difference between expected rewards and the output cumulative rewards 213 as error and adjusts the weights in the deep neural network 215, which adjusts the cumulative rewards 213 to be continually more accurate as training continues. In order to integrate pattern matching into the agent's 210 decision making process, the agent 210 adjusts the set of cumulative rewards 213 based on the discount factors 232. As mentioned above, this has the effect of emphasizing or deemphasizing certain cumulative rewards 213, and hence actions from the action set 270, depending on the similarity between the patterns utilized by pattern matching 225 and the data signal 251. After adjusting the set of cumulative rewards 213 based on the discount factors 232, the agent 210 can select an action from the action set 270 based on the set of expected rewards from the cumulative rewards 213. The agent 210 can then initiate the selected action (e.g., based on the output of the deep neural network 215).

The system architecture 200 can be employed to select actions from an action set 270 based on many types of time series data 250 and many types of unstructured context sources 240. The actions in the action set 270 are selected based on the type of data signal 251 received by the agent 210. Hence, the system architecture 200 is broadly applicable to a wide range of use cases. For example, system architecture 200 can be employed to take actions relative to any data signal 251 in order to maximize reward resulting from the actions. The following FIGs. describe various example use cases of system architecture 200. Specifically, FIGS. 3-5 describe example implementations of system architecture 200 for use in automated investment trading, autonomous driving, and automated medical diagnosis and treatment, respectively. Such embodiments are provided as concrete examples of the utility provided by system architecture 200 and should not be considered limiting.

FIG. 3 is a block diagram of an example system architecture 300 for selecting instrument trading actions with reinforced learning and based on pattern matching in accordance with various embodiments. System architecture 300 is a specific example of architecture 200. System architecture 300 includes an agent 310 that is substantially similar to agent 110 and/or 210. The agent 310 includes a deep neural network 315 that is substantially similar to deep neural network 215. The agent 310 selects and initiates actions from an action set 370, which is a specific example of action set 270. The agent 310 selects such actions based on/in response to a data signal 351 from an LSTM 363, which is substantially similar to data signal 251 and LSTM 263, respectively. The data signal 351 is obtained by a utility function 361 from time series data 350, which is substantially similar to utility function 261 and time series data 250, respectively. The agent 310 also selects such actions based on context data 320, which is an embodiment of context data 220. Context data 320 is obtained from market news 340, which is an embodiment of unstructured context sources 240. The agent 310 also adjusts expected rewards based on discount factors 332 generated by a discount factor tuner 330 based on similarity indices 331, which are substantially similar to discount factors 232, discount factor tuner 230, and long/short term predictor scores 231, respectively.

In the case shown in FIG. 3, agent 310 reacts to a data signal 351 that includes a price indicator for one or more financial instruments. Such instruments may include securities, such as stocks, bonds, mutual funds, exchange traded funds (ETFs), or other financial items that are electronically traded over an exchange market. The data signal 351 may vary based on the type of financial instrument traded by the agent 310. As a non-limiting example, the data signal 351 is obtained from time series data 350 that may include market capitalization indices 355, sector indices 352, country indices 353, stock price data 354, volatility indices, etc. Stock price data 354 indicates a price for a stock at a specified time. Market capitalization indices 355 indicate a price, at a specified time, for a predefined basket of stocks for companies of a similar market capitalization value (e.g., large cap. index, medium cap. index, small cap. index, etc.) Sector indices 352 indicate a price, at a specified time, for a predefined basket of stocks related to companies involved in a common economic activity, such as STANDARD AND POORS depository receipts (SPDRs) (e.g., Financial Select Sector (XLF), Energy Select Sector (XLE), etc.) Country indices 353 indicate a price, at a specified time, for a predefined basket of stocks for companies operating in a specified country, such as STANDARD AND POORS 500 (S&P 500), Nikkei, Financial Times Stock Exchange (FTSE), etc. The preceding examples are stock specific. However, one of skill in that art can appreciate that time series data 350 can easily be extended to bonds, funds, etc.

The context sources for interpreting the data signal 351 include related market news 340. The market news 340 acts as context sources and includes financial data documents related to the price indicator in the data signal 351. Specifically, market news 340 provides context for financial instruments and may predict and/or alter the perceived value of the financial instruments in the corresponding market(s) as represented by the data signal 351. Market news 340 may include both quantitative and qualitative publicly available data indicating the health of corresponding companies, industries, countries, markets, etc. For example, market news 340 may include financial news 341, earning reports 342, and social media posts 343. Financial news 341 are news items that track, records, analyzes, and/or interprets business, financial, and/or economic activities. Earning reports 342 are published reports and/or press releases that indicate the financial health, activities, risks, and/or plans of corresponding companies. Social media posts 343 are interactive Internet based communications from businesses, corporate leaders, and/or other company related entities. The preceding list of context sources for market news 340 is exemplary and non-limiting. The market news 340 can collectively indicate fundamental valuations such as Profit to Earnings (P/E) ratios, Price to Sales (P/S) rations, Price to earnings growth (PEG) ratios, and investor sentiment such as short interest.

Text analytics 349 is a form of feature extraction 249. Text analytics 349 is a function configured to search text based context sources for high quality actionable data and save such data in a usable format. The text analytics 349 is configured to search market news 340 and save data as context data 320 in feature vectors 322, which are substantially similar to feature vectors 222. Context data 320 may also include macroeconomic/time series data 323, which is data indicating the performance, structure, behavior, and/or decision making patterns of markets corresponding to the data signal 351. Such data can include both macro-economic data and selected time series data 350 as desired. Macroeconomic data may change at a very slow speed relative to changes in the data signal 351 (e.g., weekly, monthly and/or quarterly indices), and may be considered static relative to trading time scales. Such macroeconomic/time series data 323 can be stored as structured context data 223.

A long/short term predictor function 380 can also be employed to implement a long/short term predictor function 280. The long/short term predictor function 380 may include stock market pattern matching 325, which is an example of pattern matching 225. Stock market pattern matching 325 is a function configured to compare the data signal 351 from the time series data 350 against predefined patterns exhibited by relevant markets. Such predefined patterns may be drawn from the field of technical analysis. Stock market pattern matching 325 compares the data signal 351 with patterns (e.g., head and shoulders, inverse head and shoulders, triple top, etc.) via dynamic time warping and generates similarity indices 331. The discount factor tuner 330 can generate discount factors 332 based on the similarity indices 331. The discount factors 332 can then be employed to shift reward seeking by the agent 310 to emphasize short term gains or long term gains, depending on the pattern detected by the stock market pattern matching 325. In other examples, other long/short term predictor functions 380 can be employed to control the discount factor tuner 330, and hence alter the discount factors 332. For example, a function may check the financial news 341 for news of a corporate merger. The long/short term predictor function 380 can then control the discount factor tuner 330 to alter the discount factors 332 based on a probability that the merger will occur. The forgoing are a few examples, however one of skill in the art will recognize the long/short term predictor function 380 can include many possible predictive models for altering the discount factors 332.

The context data 320 and the data signal 351 can be processed by a deep neural network 315 at an agent 310 to generate expected/cumulative rewards. Such rewards can then be discounted based on the discount factors 332 to integrate pattern matching into the reinforced learning process. The agent 310 can employ the expected rewards to select an action from the action set 370. The action set 370 can include, for example, a buy action 377, a sell action 379, a hold action 375, a buy to cover action 373, and a sell short action 371. A buy action 377, when initiated, buys a financial instrument to take advantage of expected rewards caused by movements in the data signal 351. The sell action 379 sells a financial instrument to take profit or mitigate loss related to a previously purchased financial instrument. A hold action 375 is an action to maintain current ownership in previously purchased financial instrument in order to obtain more future profit. A sell short action 371 is an action to promise to sell an unowned financial instrument at a current price based on the possibility of buying the financial instrument at a later time at for a cheaper price and hence achieving the price difference as a reward. A buy to cover action 373 is an action to buy a financial instrument to complete an agreed upon sell short action 371.

The following is a specific example mechanism for training and deploying a system according to system architecture 300. A historical price dataset for a stock, bond, currency, mutual fund or other financial instrument (e.g., stock price data 354) is taken as time series data 350. A window size of n time periods (daily, weekly or monthly) may be chosen, where n is an integer value. The data may be converted to a trend by calculating the inter-time period difference across the n time intervals. Using a utility function 361 the trend data is normalized and converted to discrete space using binning to generate a data signal 351. Discretization helps generalize the model to any financial instrument. This utility function 361 generates an n-sized trend vector for the financial instruments considered for a trading strategy. In addition, similar n-sized vectors can be generated for the sector indices 352 representing the instruments (such as SPDRs like XLF, XLE etc.), broad country indices 353 where the company is listed (like S&P 500, Nikkei, FTSE etc.), and market cap indices 355 (like Small, Mid and Large caps). LSTM 363 is used to encode the structural nature of the time series trend. LSTM 363 may convert the n-sized vectors into a multi-dimensional input capturing trends to be fed into the state definition in the deep neural network 315 along with any additional external data inputs defined as context data 320 (such as technical pattern similarity, macro-economic data 323, and quantified inputs from text data such as financial news 341, social media 343, earnings reports 342, etc.). This causes architecture 300 to act as a hybrid network.

To extract the information related to patterns in the market like head and shoulder, inverse head and shoulder, triple tops etc., a Dynamic Time Warping (DTW) algorithm is applied by stock market pattern matching 325 to find the similarity between predefined patterns (e.g., templates) and the price pattern of the financial instruments. The stock market pattern matching 325 normalizes the financial instruments data to the scale of the template and applies DTW to find the similarity indices 331. Text analytics 349 is performed as a feature extraction on the financial news 341, earnings reports 342, and social media 343. Sentiments data and feature values are extracted as quantitative features in feature vectors 322.

For each trading time period during training, a random action can be generated by the agent 310. This accounts for the stochastic training process for the reinforcement learning model. The probability of the stochastic prediction of the action decreases as and when experience replay is performed. This approach acts as an exploration and exploitation process during the training phase that includes controlled random action.

The state and the corresponding action selected from the action set 370 are stored in an inventory and sent to the model system architecture 300 in batches for experience replay. Experience replay is a technique to make the model learn sequentially with the actions taken stochastically, which act as the training examples to the deep neural network 315. Experience replay trains the model in batches.

The system architecture 300 is trained with the aforementioned inputs and a vector corresponding to the rewards for the actions hold 375, buy 377, and sell 379 is generated for long only trading strategies. The output of the hybrid network is the vector of size k corresponding to the expected reward of the various actions in the trade scenario. The vector is the sum of the expected immediate profit and the future expected profits after taking the specific action as modified by the corresponding discount factor 332. For example, in a long trade, the output size is three for buy 377, sell 379, and hold 375. For short trades the output size is three for buy to cover 373, sell short 371, and hold 375. For long-short boxed position trades, the output size is five for buy to cover 373, sell short 371, hold 375, buy 377, and sell 379.

The reward for each action is dependent on the profit or loss made in that trade. A buy 377 and sell 379, which is a long trade are coupled together. Similarly, sell short 371 and buy to cover 373 in a short trade are coupled together. If a box strategy is used after a sharp move by the market in the reverse direction causing a sudden paper loss, an opposite trade may be initiated by the agent 310, for example by pairing a sell short 371 with a long buy 377 or vice-versa. This allows the agent 310 to book a profit on the unexpected move and then wait to close out the paper loss at minimal to zero loss on price reversion to close the gap.

The discount factor 332 in the Q function and is used for optimization apart from the reward (e.g., profit or loss in a trade). The discount factor 332 varies based on the external environment data. The discount factor 332 may be a value from zero to one, with zero indicating a completely neglecting future rewards and one indicating considering future rewards with equal weight for infinite time periods. For example, if the pattern similarity index 331 is high in detecting a head and shoulder pattern, the discount factor 332 may be long sighted to allow the pattern to run to completion to achieve a technical target. Hence the discount factor 332 is increased accordingly. Similarly, news related to mergers of companies that could result in an arbitrage environment, causes an increase in the discount factor 332 making the agent 310 far-sighted to wait through temporary mispricing and obtain beneficial profit on an eventual merger price. For low probability mergers, the discount factor 332 is decreased and a short-sighed approach is taken to quickly close out the trade.

When the agent 310 predicts a buy 377 during the training phase, the specific state variable is saved in the history. When the model predicts a sell 379 for the long trade, the reinforcement learning mode is trained with the reward of the profit or loss made in this trade for both the buy and sell action using state variables as inputs and the reward as the output to the hybrid network. Instead of using the regular profit from a trade, an annualized percentage profit may be computed factoring the time. This approach incentivizes short duration trades with large percentage moves versus trades that take a long time period to achieve the same profit. The optimality of the trade, of both buy 377 and sell 379 is determined when the model sells for a profit/loss factoring the time taken to realize the gain or loss.

When the system predicts a sell short 371 during the training phase, the specific state variable is saved in the history. When the agent 310 predicts buy to cover 373 for the short 371 trade, the reinforcement learning mode is trained with the reward of the profit or loss made in the trade for both the sell short 371 and buy to cover 373 action using state variables as inputs and the reward as the output to the hybrid network. The optimality of the trade of both sell short 371 and buy to cover 373 is determined when the model buys to cover 373 for a profit/loss.

The agent 310 may be trained with the number of examples specified by the batch size using the experience replay. The deep neural network 315 is trained using the state variables as input and the value function calculated using immediate reward and delayed reward. For this purpose, a discount factor of 0.95 may be employed during training, which account for ninety five percent far sightedness. This approach allows the agent 310 to looks into rewards to be attained in the future portions of the training data at the corresponding future state variables in the training data. This also allows the agent 310 to determine the how the deep neural network 315 would act in such as state.

It should be noted that the agent 310 may be trained without trading constraints. This allows the agent 310 to predict the best action in a specific state irrespective of constraints such as initial investment, money caps set for shorting, trade processing fees, short capital interest, etc. The agent 310 may be deployed for institutional use (e.g., not individual investors), and hence the architecture 300 presumes new money is invested on model action recommendations without employing a fixed limit of investment capital on hand.

Once the agent 310 is trained as discussed above, the agent 310 can select actions from the action set 370 based on real time context data 320 and time series data 350 based on patterns detected by stock market pattern matching 325. Such actions can be supervised trades and/or automated trades, depending on the example.

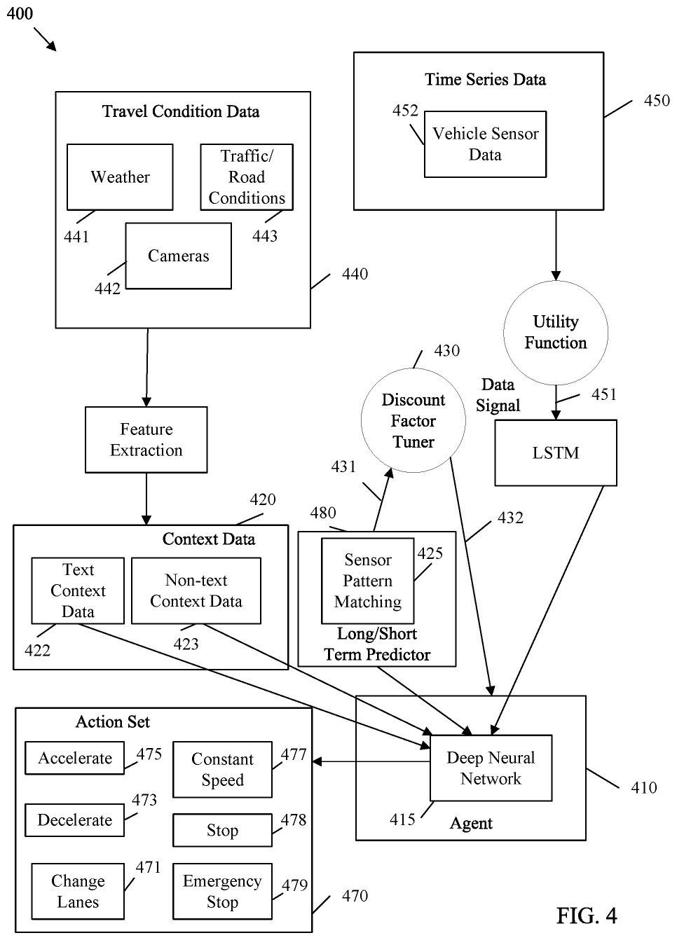

FIG. 4 is a block diagram of an example system architecture 400 for selecting autonomous driving actions with reinforced learning and based on pattern matching in accordance with various embodiments. System architecture 400 is a specific example of architecture 200, and may include components that operate in a manner that is substantially similar to architecture 300 with changes to support different input data and different actions. In the interests of clarity and brevity, components are presumed to act in a manner that is substantially similar to corresponding components in architecture 200 and/or 300 unless otherwise stated.

Architecture 400 is employed to perform road condition analysis and related changes during travel of an autonomous vehicle. It should be noted that architecture 400 may not function as a complete autonomous driving system, and may be employed in conjunction with other systems for the particular sub-task of reacting to real time changes occurring while an autonomous vehicle is in transit. For example, architecture 400 may be employed to support collision avoidance in the case of road debris. Architecture 400 employs an agent 410 with a deep neural network 415 to implement agent 210 and deep neural network 315, respectively. Agent 410 may employ deep neural network 415, for example, to both recognize road debris and determine the expected rewards associated with avoiding the road debris in some cases or ignoring the road debris in other cases (e.g., when road debris avoidance would potentially result in a more serious accident).

The agent 410 receives a data signal 451 based on time series data 450, which is an implementation of data signal 251 and time series data 250, respectively. The time series data 450, and hence the data signal 451, includes vehicle sensor data 452. The vehicle sensor data 452 may include, for example, images from camera(s) mounted on an autonomous vehicle. The deep neural network 415 at the agent 410 can use the data signal 451 from the vehicle sensor data 452 to determine the presence, and/or movement thereof, of an object relative to the direction of motion of the vehicle (e.g., in front, behind, etc.). The deep neural network 415 can then select an action from the action set 470, which implements action set 370, in order to maximize expected rewards relative to the detected object. The object may be road debris, wild life, another vehicle, road construction equipment, etc. Expected rewards may include crash avoidance, damage mitigation, safety of vehicle passengers, safety of bystanders, safety of other vehicles, etc. The deep neural network 415 can select various actions from the action set 470, such as an accelerate action 475 to increase current vehicle speed, a decelerate action 473 to decrease current vehicle speed, a constant speed action 477 to maintain current speed, a change lanes action 471 to change vehicle position relative to an object, a stop action 478 to reduce speed to a stop, and an emergency stop action 479 to stop the vehicle as quickly as possible. The action set 470 may also contain any other action a vehicle operator may employ to control a vehicle.

In order to determine rewards for the action set 470, the deep neural network 415 considers travel condition data 440 as an unstructured context source 240. Travel condition data 440 may include any data relevant to driving conditions experienced by a vehicle. Travel conditions may include weather 441, traffic and/or road conditions 443, external cameras 442 such as street and bridge cameras, etc. The travel condition data 440 may be obtained from crowd sourced traffic services, government traffic services, social network posts/messages, weather services, internet of things (IoT) capable devices, etc. Hence, the travel condition data 440 can include qualitative data such as images and sounds as well as quantitative data, which is stored in context data 420. Context data 420 implements context data 220. The qualitative data is extracted and stored as non-text context data 423, and the quantitative data is stored as text context data 422, both of which are included in the context data. Such context data provide context for the data signal 451. For example, context data indicating rainy weather or road ice can indicate to the deep neural network 415 that an emergency stop 479 is associated with lower rewards due to increased accident risk. As another example, context data indicating road construction can indicate to the deep neural network 415 that an accelerate action 475 is associated with lower rewards due to the likelihood of pedestrians near the roadway. As such, the deep neural network 415 can consider the context data 420 when determining rewards for taking an action relative to an object detected from the vehicle sensor data 452.

Architecture 400 includes a short/long term predictor 480 to implement short/long term predictor 280. For example, the short/long term predictor 480 may include sensor pattern matching 425, which implements pattern matching 225. Sensor pattern matching 425 can be used to provide further context. Specifically, the data signal 451 can be compared to various patterns to determine the nature of the object denoted by the vehicle sensor data 452. For example, a data signal 451 that indicates the presence of an item that matches a pattern for a plastic bag may be safe to ignore. Hence, the sensor patter matching 425 may apply DTW to generate similarity indices 431, which are considered by a discount factor tuner 430 when generating discount factors 432. Such components implement long/short term predictor scores 231, discount factor tuner 230, and discount factors 232, respectively. In the case of an item in the data signal 451 that matches a pattern for a plastic bag, the discount factors 432 may decrease the rewards to varying degrees that are associated with sudden changes in vehicle operation, such as emergency stop action 479 and stop action 478. In the case of an item in the data signal 451 that matches a pattern for a person, the discount factors 432 may decrease the rewards to varying degrees that are associated with a potential collision, such as accelerate action 475, constant speed action 477, and change lanes action 471. In the case of an item in the data signal 451 that matches a pattern for another vehicle, the discount factors 432 may decrease the rewards to varying degrees that are associated with significant changes in vehicle operation or potential collision, such as emergency stop action 479, stop action 478, accelerate action 475, etc. In other examples, other long/short term predictor functions 480 can be employed to control the discount factor tuner 430, and hence alter the discount factors 432. For example, a function may check the weather 441 or the traffic/road conditions 443 for indications of poor driving conditions, such as poor weather (e.g., fog, heavy rain, snow, etc.) or poor traffic (e.g., traffic congestion). The long/short term predictor function 480 can then control the discount factor tuner 430 to alter the discount factors 432 based on the poor driving conditions. For example, such poor driving conditions may push the discount factors 432 toward zero and hence emphasize careful driving actions. The forgoing are a few examples, however one of skill in the art will recognize the long/short term predictor function 480 can include many possible predictive models for altering the discount factors 432.

As the context data 420 includes travel condition data 440, the deep neural network 415 can select actions from the action set 470 based on the presence of an object in the data signal 451, based on the effect of travel condition data 440 on such an action, and based on sensor pattern matching 425 to determine the nature of the object in the data signal 451. As a wide variety of actions, contexts, patterns, and sensors data can be employed by an autonomous system, the specific items discussed with respect to architecture 400 should be considered exemplary and non-limiting.

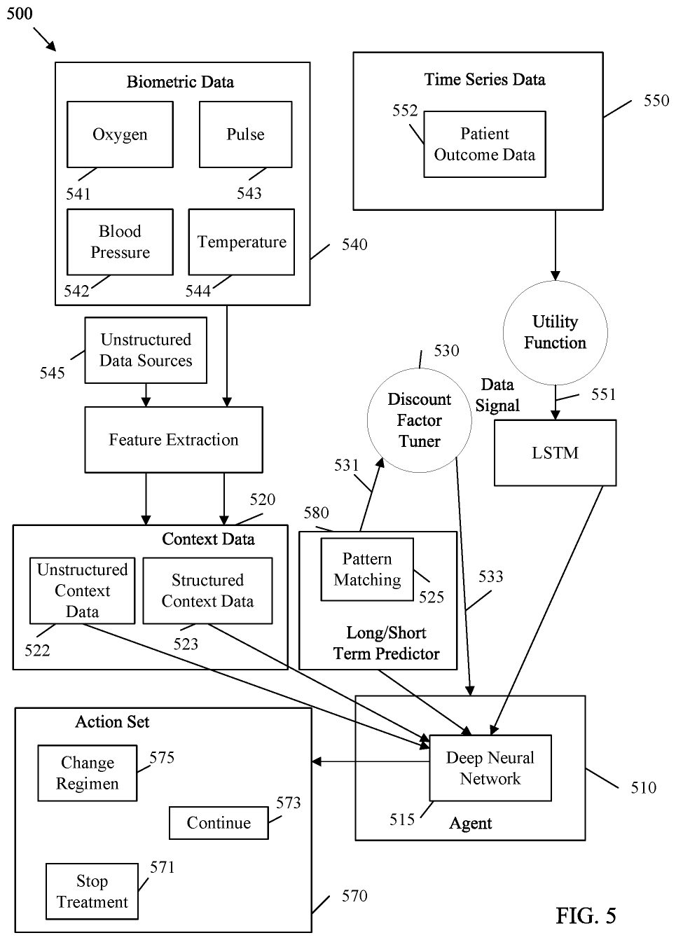

FIG. 5 is a block diagram of an example system architecture 500 for selecting healthcare actions with reinforced learning and based on pattern matching in accordance with various embodiments. System architecture 500 is a specific example of architecture 200, and may include components that operate in a manner that is substantially similar to architecture 300 and/or 400 with changes to support different input data and different actions. In the interests of clarity and brevity, components are presumed to act in a manner that is substantially similar to corresponding components in architecture 200, 300 and/or 400 unless otherwise stated.

Architecture 500 includes an agent 510 with a deep neural network 515, which are implementations of an agent 210 and a deep neural network 215, respectively. The agent 510 is configured to act as an automated doctor and hence make healthcare decisions/suggestions. Such decisions may be initiated by being presented directly to a patient or provided to a healthcare professional for confirmation in a supervised setting. The agent 510 can initiate actions from an action set 570 that implements an action set 270. The action set 570 may include a change regimen action 575, a continue regimen action 573, and a stop treatment action 571. The change regimen action 575 indicates that a new procedure should be employed for a patient. Such procedure may include a medication change, a referral for surgery, a referral for physical therapy, or other therapeutic medical procedure. The change regimen action 575 is selected when current treatment procedure is failing to produce sufficient therapeutic results as rewards. The continue regimen action 573 indicates the current treatment procedure is producing the best expected results (e.g., rewards) of the available alternative treatment procedures and should be continued. The stop treatment action 571 indicates that treatment should be discontinued, for example because the patient has overcome a malady and/or because further treatment is unlikely to provide additional positive results. The results/rewards considered by the agent 510 when selecting an action may include normalization of medical indicators, such as blood glucose levels (A1C), blood pressure, lipids, hormones, etc.

The deep neural network 515 selects actions based on time series data, which implements time series data 250. Specifically, the time series data 550 includes patient outcome data 552. The patient outcome data 552 includes any medical indicators employed to diagnose illness, such as cholesterol, A1C, blood pressure, lipids, hormones, rheumatoid arthritis (RA) factors, prostate specific antigen (PSA), cancer bio-markers, etc. The patient outcome data 552 is formatted into a data signal 551, which implements a data signal 251. The patient outcome data 552 is formatted into the data signal 551 by any of the mechanisms discussed in the previous embodiments.

Biometric data 540 and other unstructured data sources 545 implement unstructured context sources 240, and hence provide context for the patient outcome data 552 under consideration by the deep neural network 515. The biometric data 540 is a body measurement or calculation, and is generally measured in a structured quantitative manner by medical equipment. Such biometric data 540 may include patient oxygen 541 levels, patient pulse 543, patient blood pressure 542, patient temperature 544, etc. Such biometric data 540 provide context for the patient outcome data 552. Further, additional unstructured data sources 545 may also provide context for the patient outcome data 552. Such unstructured data sources 545 may include images, such as x-rays, computed tomography (CT) scans, positron emission tomography (PET) scans, or other imaging data. The biometric data 540 is extracted by medical biometric devices, such as pulse oximeters, heart rate/pulse monitors, blood pressure monitors, glucometers, etc. The unstructured data sources 545 may be extracted via image recognition devices. The biometric data 540 and the unstructured data sources 545 are then stored as context data 520 as unstructured context data 522 and structured context data 523, respectively. Hence, the context data 520 implements context data 220. The context data 520 can be considered by the deep neural network 515 to provide context for the data signal 551 including patient outcome data 552.

The architecture 500 long/short term predictor function 580, such a pattern matching 525 function, that implements long/short term predictor function 280 and pattern matching 225, respectively. Pattern matching 525 compares the digital signal to various patterns, for example via DTW, to determine similarity indices 531. As an example, electrocardiogram (EKG) data can be stored as patterns. The pattern matching 525 can then compare the data signal 551 to the EKG patterns to detect irregular heart rhythms, for example. Other known patterns may also be considered, depending on the patient symptoms, current treatment, etc. The discount factor tuner 530 can employ the similarity indices 531 to generate discount factors 533, which implements discount factor tuner 230, long/short term predictor scores 231, and discount factors 233, respectively. The agent 510 can then emphasize or deemphasize rewards for corresponding actions based on the nature of the pattern. For example, when pattern matching 525 detects an abnormal heart rhythm based on the pattern, the discount factor 533 can be progressively reduced toward zero to weight near term interventions, for example via the change regimen action 575. The agent 510 can then select an action from the action set 570 based on the expected rewards resulting from the context data 520, the patient outcome data 552, and the discount factor 533. In other examples, other long/short term predictor functions 580 can be employed to control the discount factor tuner 530, and hence alter the discount factors 533. For example, a function may check the blood pressure 542 for indications of potential imminent health consequences (e.g., heart attack, stroke, etc.). The long/short term predictor function 580 can then control the discount factor tuner 530 to alter the discount factors 533 based on the indications of potential imminent health consequences. For example, such indications of potential imminent health consequences may push the discount factors 533 toward zero and hence emphasize intervention related actions. The forgoing are a few examples, however one of skill in the art will recognize the long/short term predictor function 580 can include many possible predictive models for altering the discount factors 533.

As shown by the preceding examples, architecture 200 can be implemented in many contexts to provide for pattern matching to emphasize or deemphasize expected rewards determined by a deep neural network based on a data signal and associated context data. As noted above, these examples are intended to showcase various practical implementations of the disclosed technology in order to improve AI in corresponding fields of use. As such, these examples should not be considered limiting unless otherwise indicated.

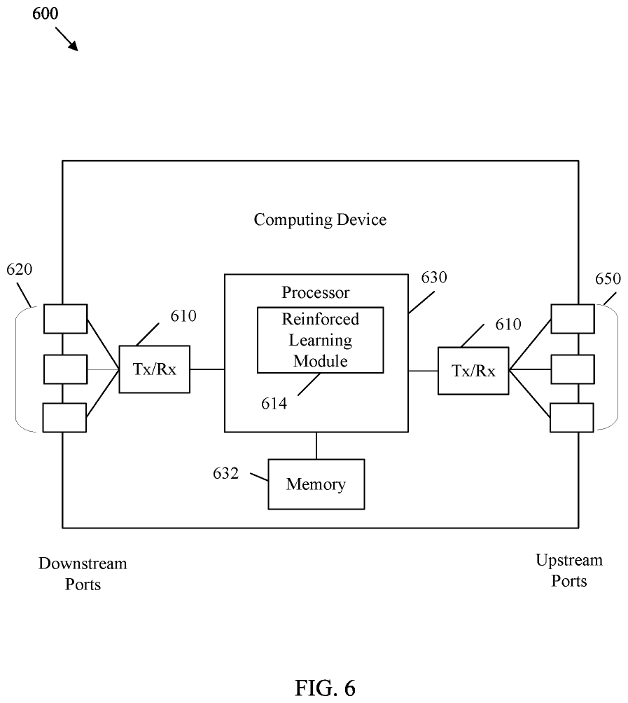

FIG. 6 is a block diagram of an example computing device 600 in accordance with various embodiments. Computing device 600 is any suitable processing device capable of performing the functions disclosed herein such as a processing device, a user equipment, an IoT device, a computer system, a server, a computing resource, a cloud-computing node, a cognitive computing system, a vehicle controller, etc. Computing device 600 is configured to implement at least some of the features/methods disclosed herein, for example, pattern matching in reinforced learning, such as described above with respect to reinforced learning system 100, architecture 200, 300, 400, and/or 500.

For example, the computing device 600 is implemented as, or implements, any one or more of an agent 110, 210, 310, 410, and/or 510, system 100, and/or architecture 200, 300, 400, and/or 500. In various embodiments, for instance, the features/methods of this disclosure are implemented using hardware, firmware, and/or software (e.g., such as software modules) installed to run on hardware. In some embodiments, the software utilizes one or more software development kits (SDKs) or SDK functions to perform at least some of the features/methods of this disclosure. In some examples, the computing device 600 is an all-in-one device that performs each of the aforementioned operations of the present disclosure, or the computing device 600 is a node that performs any one or more, or portion of one or more, of the aforementioned operations. In one embodiment, the computing device 600 is an apparatus and/or system configured to provide the pattern matching in reinforced learning as described with respect to system 100, and/or architecture 200, 300, 400, and/or 500, for example, according to a computer program product executed on, or by, at least one processor 630.

The computing device 600 comprises downstream ports 620, upstream ports 650, and/or transceiver units (Tx/Rx) 610 for communicating data upstream and/or downstream over a network. The Tx/Rx 610 can act as upstream and downstream receivers, transmitters, and/or transceivers, depending on the example. The computing device 600 also includes a processor 630 including a logic unit and/or central processing unit (CPU) to process the data and a memory 632 for storing the data. The computing device 600 may also comprise optical-to-electrical (OE) components, electrical-to-optical (EO) components, and/or wireless communication components coupled to the upstream ports 650 and/or downstream ports 620 for communication of data via electrical, optical, and/or wireless communication networks.

The processor 630 is implemented by hardware and software. The processor 630 may be implemented as one or more CPU chips, cores (e.g., as a multi-core processor), field-programmable gate arrays (FPGAs), application specific integrated circuits (ASICs), and digital signal processors (DSPs). The processor 630 is in communication with the downstream ports 620, Tx/Rx units 610, upstream ports 650, and memory 632. The processor 630 comprises a reinforced learning module 614. The reinforced learning module 614 implements the disclosed embodiments described herein, such as system 100, and/or architecture 200, 300, 400, and/or 500. The reinforced learning module 614 may perform reinforced learning to train a deep neural network and operate the deep neural network to select actions from an action set to maximize expected rewards. Such action selection is based on a data signal, context data related to the data signal, and discount factors related to pattern matching. The inclusion of the reinforced learning module 614 allows for increased functionality by reinforced learning based AIs (e.g., by including pattern matching in action selection processes). Therefore the inclusion of the reinforced learning module 614 provides a substantial improvement to the functionality of the computing device 600 and effects a transformation of the computing device 600 to a different state. Alternatively, the computing device 600 can be implemented as instructions stored in the memory 632 and executed by the processor 630 (e.g., as a computer program product stored on a non-transitory medium).

FIG. 6 also illustrates that a memory module 632 is coupled to the processor 630 and is a non-transitory medium configured to store various types of data. Memory module 632 comprises memory devices including secondary storage, read-only memory (ROM), and random access memory (RAM). The secondary storage is typically comprised of one or more disk drives, optical drives, solid-state drives (SSDs), and/or tape drives and is used for non-volatile storage of data and as an over-flow storage device if the RAM is not large enough to hold all working data. The secondary storage is used to store programs that are loaded into the RAM when such programs are selected for execution. The ROM is used to store instructions and perhaps data that are read during program execution. The ROM is a non-volatile memory device that typically has a small memory capacity relative to the larger memory capacity of the secondary storage. The RAM is used to store volatile data and perhaps to store instructions. Access to both the ROM and RAM is typically faster than to the secondary storage.

The memory module 632 houses the instructions for carrying out the various embodiments described herein. For example, the memory module 632 may comprise a computer program product, which is executed by processor 630.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, procedural programming languages, such as the “C” programming language, and functional programming languages such as Haskell or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider (ISP)). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the FIGS. illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the FIGs. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

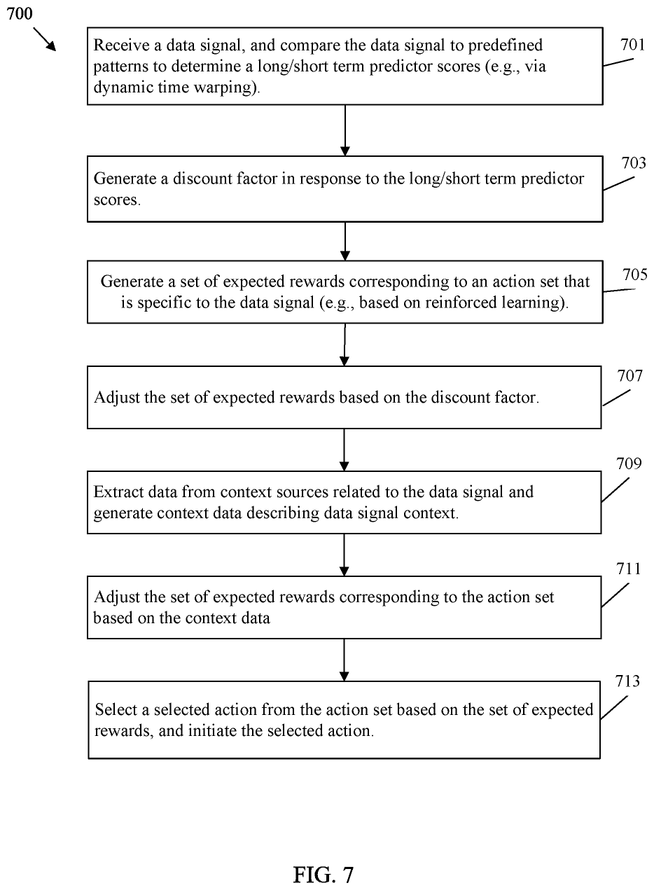

FIG. 7 is a flowchart of an example method 700 of selecting an action with reinforced learning and based on pattern matching in accordance with various embodiments. Specifically, method 700 may be implemented in a system 100, an architecture 200, 300, 400, and/or 500, and/or a computing device 600. The method 700 allows an agent with a deep neural network to select actions from an action set based on a data signal, context data, and discount factors generated according to pattern matching as discussed above.

At block 701, a data signal is received, for example from time series data. The data signal is compared to one or more predefined patterns to determine one or more long/short term predictor scores. For example, the long/short term predictor scores may include similarity indices generated according to pattern matching. In such a case, comparing the data signal to the predefined patterns may include applying DWT to determine the similarity indices. Depending on the example, the data signal of method 700 can be a price indicator for a financial instrument, vehicle sensor data, or patient outcome data.

At block 703, a discount factor is generated in response to the long/short term predictor scores. The discount factor can be used to emphasis or deemphasize particular actions by causing the a deep neural network to emphasize short term rewards or long term rewards, depending on the pattern.

At block 705, a set of expected rewards is generated. Such expected rewards correspond to an action set that is specific to the data signal. Further, the expected rewards are generated according to reinforced learning. At block 707, the set of expected rewards is adjusted based on the discount factor.

At block 709, quantitative and/or qualitative data are extracted from context sources that are related to the data signal. The quantitative and/or qualitative data is saved as context data. Hence, context data is generated that describes data signal context based on the quantitative/qualitative data. Depending on the example, the context sources can be financial data documents related to a price indicator, travel condition data, or biometric data.

At block 711, the set of expected rewards corresponding to the action set are adjusted based on the context data. At block 713, a selected action can be selected from the action set based on the set of expected rewards. The selected action can then be initiated. In a financial based example, the action set can include a buy action, a sell action, a hold action, a buy to cover action and a sell short action. In an autonomous driving based example, the action set can include an accelerate action, a decelerate action, a constant speed action, a stop action, an emergency stop action, and a change lanes action. In a healthcare based example, the action set can include a change regimen action, a continue regimen action, and a stop treatment action.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct wired or wireless connection. Thus, if a first device couples to a second device, that connection may be through a direct connection or through an indirect connection via other intervening devices and/or connections. Unless otherwise stated, “about,” “approximately,” or “substantially” preceding a value means+/−10 percent of the stated value or reference.

What is claimed is:

1. A computer program product for selecting an action based on reinforced learning, the computer program product comprising a computer readable storage medium having program instructions embodied therewith, the program instructions executable by a processor to cause the processor to:
receive a data signal;
compare the data signal to one or more predefined patterns to determine one or more long/short term predictor scores;
generate a discount factor in response to the long/short term predictor scores;
generate a set of expected rewards corresponding to an action set specific to the data signal, the expected rewards generated according to reinforced learning;
adjust the set of expected rewards based on the discount factor;
select a selected action from the action set based on the set of expected rewards; and
initiate the selected action.

2. The computer program product of claim 1, wherein the selected action is selected based on output from a deep neural network.

3. The computer program product of claim 1, wherein comparing the data signal to the predefined patterns includes applying dynamic time warping to determine similarity indices as long/short term predictor scores.

4. The computer program product of claim 1, wherein the program instructions are further executable by the processor to:
extract quantitative data from context sources related to the data signal;
generate context data describing data signal context based on the quantitative data; and
generate the set of expected rewards corresponding to the action set based in part on the context data.

5. The computer program product of claim 4, wherein the data signal is a price indicator for a financial instrument, wherein the context sources are financial data documents related to the price indicator, and wherein the action set includes a buy action, a sell action, and a hold action.

6. The computer program product of claim 4, wherein the action set includes a buy to cover action and a sell short action.

7. The computer program product of claim 4, wherein the data signal is vehicle sensor data, wherein the context sources include travel condition data, and wherein the action set includes an accelerate action, a decelerate action, a constant speed action, a stop action, an emergency stop action, and a change lanes action.

8. The computer program product of claim 4, wherein the data signal is patient data, wherein the context sources include biometric data, and wherein the action set includes a change regimen action, a continue regimen action, and a stop treatment action.

9. A computer-implemented method, comprising:
receiving a data signal;
comparing the data signal to one or more predefined patterns to determine one or more long/short term predictor scores;
adjusting a discount factor in response to the long/short term predictor scores;
generate a set of expected rewards corresponding to an action set specific to the data signal, the set of expected rewards generated according to reinforced learning;
adjusting the set of expected rewards based on the discount factor;
selecting a selected action from the action set based on the set of expected rewards; and
initiating the selected action.

10. The computer implemented method of claim 9, wherein comparing the data signal to the predefined patterns includes applying dynamic time warping to determine similarity indices as long/short term predictor scores.

11. The computer implemented method of claim 9, further comprising:
extracting quantitative data from context sources related to the data signal;
generating context data describing data signal context based on the quantitative data; and
adjusting the set of expected rewards corresponding to the action set based on the context data.

12. The computer implemented method of claim 11, wherein the data signal is a price indicator for a financial instrument, wherein the context sources are financial data documents related to the price indicator, and wherein the action set includes a buy action, a sell action, and a hold action.

13. The computer implemented method of claim 11, wherein the action set includes a buy to cover action and a sell short action.

14. The computer implemented method of claim 11, wherein the data signal is vehicle sensor data, wherein the context sources include travel condition data, and wherein the action set includes an accelerate action, a decelerate action, a constant speed action, a stop action, an emergency stop action, and a change lanes action.

15. The computer implemented method of claim 11, wherein the data signal is patient data, wherein the context sources include biometric data, and wherein the action set includes a change regimen action, a continue regimen action, and a stop treatment action.

16. A computing device comprising:
a memory configured to:
store one or more predefined patterns;
store an action set; and
store a deep neural network;
a receiver configured to receive a data signal; and
a processor coupled to the memory and the receiver, the processor configured to:
compare the data signal to the predefined patterns to determine one or more long/short term predictor scores;
generate a discount factor in response to the long/short term predictor scores;
generate a set of expected rewards corresponding to the action set and specific to the data signal, the expected rewards generated according to reinforced learning;
adjust the set of expected rewards based on the discount factor;
select a selected action from the action set based on the set of expected rewards; and
initiate the selected action.

17. The computing device of claim 16, wherein the processor is further configured to:
extract quantitative data from context sources related to the data signal;
generate context data describing data signal context based on the quantitative data; and
generate the set of expected rewards corresponding to the action set based in part on the context data.

18. The computing device of claim 17, wherein the data signal is a price indicator for a financial instrument, wherein the context sources are financial data documents related to the price indicator, and wherein the action set include a buy action, a sell action, a hold action, a buy to cover action, and a sell short action.

19. The computing device of claim 17, wherein the data signal is vehicle sensor data, wherein the context sources include travel condition data, and wherein the action set includes an accelerate action, a decelerate action, a constant speed action, a stop action, an emergency stop action, and a change lanes action.

20. The computing device of claim 17, wherein the data signal is patient data, wherein the context sources include biometric data, and wherein the action set includes a change regimen action, a continue regimen action, and a stop treatment action.
